(19) United States
(12) Patent Application Publication
(10) Pub. No.: US 2009/0077862 A1
(43) Pub. Date: Mar. 26, 2009

(54) LUBRICITY ADDITIVES AND METHODS OF PRODUCING LUBRICITY ADDITIVES

(76) Inventor: Scott D. SCHWAB, Richmond, VA (US)

Correspondence Address: BERENATO, WHITE, & STAVISH, 6550 ROCK SPRING DRIVE, SUITE 240, BETHESDA, MD, 20817, US

(21) Appl. No.: 11/860,651

(22) Filed: Sep. 25, 2007

(51) Int. Cl. C10L 1/188; C10M 169/00; C11B 3/12

(52) U.S. Cl. 44/307; 508/459; 554/191

(57) ABSTRACT

Methods of producing lubricity additives and lubricity additives are disclosed. The methods of producing lubricity additives include removing sulfur from a tall oil fatty acid to a level of about 25 ppm or less and fractionally crystallizing the tall oil fatty acid to produce a lubricity additive which does not form crystals at temperatures as low as about −20° F. The sulfur may be removed prior to or after fractionally crystallizing the tall oil fatty acid. Methods of improving the lubricity of a fuel are also disclosed.

### FIELD OF THE INVENTION

The present disclosure relates to methods of producing fuel additives, in particular to producing lubricity additives having a low sulfur content which remain crystal free at temperatures as low as about −20° F., and to lubricity additives and methods of improving the lubricity of a fuel.

### BACKGROUND OF THE INVENTION

Environmental concerns have led to regulatory mandates requiring sulfur levels to be reduced in fuels. Low sulfur fuels are known to be less lubricating and therefore low sulfur and ultra-low sulfur fuels, i.e., fuels having sulfur levels of 15 ppm or less, are typically treated with lubricity additives. However, fuel additives, including lubricity additives, are also subject to regulatory standards relating to reduced sulfur levels. Specifically, U.S. regulations require that most fuel additives contain no more than 15 ppm sulfur.

Additionally, many fuel compositions and fuel additives, including lubricity additives, are stored in outdoor tanks and therefore need to remain liquid and at a low viscosity even at low temperatures. Many commonly known lubricity additives, despite having excellent lubricating properties, do not remain free of crystals at low temperatures.

Tall oil fatty acids (TOFAs) are considered valuable for use in various applications due to their good lubricating properties. Tall oil is a by-product in the manufacture of paper pulp by digestion of wood with alkaline solutions of sodium sulfide. Tall oil fatty acids may be isolated from the tall oil using various known processing techniques. However, tall oil fatty acids often contain undesirably high levels of sulfur which is introduced during the pulping process. Furthermore, tall oil fatty acids, even when greatly diluted in solvent, typically do not remain free of crystals at low temperatures. Therefore, a need exists to produce a low sulfur fuel additive composition that provides improved lubricity and low temperature properties to the additive and also to the subsequent finished fuel.

### SUMMARY OF THE INVENTION

In accordance with one embodiment, a method of producing a lubricity additive comprises removing sulfur from a tall oil fatty acid to a level of about 25 ppm or less and fractionally crystallizing the tall oil fatty acid to produce a lubricity additive in which crystals do not form at temperatures as low as about −20° F. In some embodiments, the sulfur is removed prior to fractionally crystallizing the tall oil fatty acid and in other embodiments the sulfur is removed after fractionally crystallizing the tall oil fatty acid.

In accordance with another embodiment, a lubricity additive is provided which comprises a fraction of tall oil fatty acids having a sulfur content of less than about 25 ppm wherein the lubricity additive does not form crystals at temperatures as low as about −20° F.

In accordance with another embodiment, a method of improving the lubricity of a fuel comprises removing sulfur from a tall oil fatty acid to a level of about 25 ppm or less, fractionally crystallizing the tall oil fatty acid, diluting the fractionally crystallized fatty acid with a solvent to form a lubricity additive which does not form crystals at temperatures as low as about −20° F., and adding the lubricity additive to a fuel. In some embodiments, the sulfur is removed prior to fractionally crystallizing the tall oil fatty acid and in other embodiments the sulfur is removed after fractionally crystallizing the tall oil fatty acid.

The methods and compositions provided herein are useful in the preparation additives for fuels, such as middle distillate fuels, diesel fuels, biodiesel fuels, jet fuels, home heating oil and bunker fuels, as well as the preparation of additives for various lubricant applications. Advantages, as well as additional inventive features will be apparent from the description of the invention provided herein.

### DETAILED DESCRIPTION OF THE PREFERRED EMBODIMENTS

Fuel additives for improving the lubricity of fuel, e.g., lubricity additives, may be variously produced. In accordance with an embodiment, a method of producing a lubricity additive may comprise removing sulfur from a tall oil fatty acid to a level of about 25 ppm or less and fractionally crystallizing the tall oil fatty acid to produce a lubricity additive.

As used herein, the term “tall oil fatty acid” refers to one or more compounds of the formula R¹—COOH wherein R¹ is a hydrocarbon having at least 4 carbon atoms and the —COOH group is an acid group. Typically, the R¹ group has no more than 99 carbons, so that the fatty acid has a total of no more than 100 carbons. For example, in many embodiments, R¹ contains 4 to 29 carbons, for example, 7 to 25 carbons, and as a further example, 15 to 23 carbons. In some embodiments, R¹ may be substituted with one or more hydroxyl groups, e.g., a hydrogen atom in R¹ may be replaced with a hydroxyl (—OH) group. The number of hydroxyl groups in the fatty acid may vary widely based upon the number of carbon atoms present in the fatty acid. For example, in some embodiments, the fatty acid may contain from 1 to 30 hydroxyl groups.

Independent of the number of carbons in R¹, in various embodiments, R¹ may be linear, branched, or cyclic and independently may be saturated or unsaturated. Unsaturated fatty acids may include monounsaturated and/or polyunsaturated fatty acids, where polyunsaturated fatty acids include 2, 3, 4 or more sites of unsaturation. A site of unsaturation is a double bond between two adjacent carbons of R¹. An exemplary saturated tall oil fatty acid may include stearic acid. Exemplary unsaturated tall oil fatty acids may include oleic acid (monounsaturated), linoleic acid (polyunsaturated), and linolenic acid (polyunsaturated).

The tall oil fatty acids of the present disclosure may comprise a single fatty acid structure, or in many embodiments, the tall oil fatty acid comprises a mixture of different fatty acid structures. Different fatty acid structures may comprise fatty acids having non-identical R¹ groups. For example, in many embodiments the tall oil fatty acid may include a mixture of saturated and unsaturated tall oil fatty acids, as well as a mixture of linear, branched and/or cyclic fatty acids.

In an embodiment, the tall oil fatty acid may comprise at least about 50 wt %, for example, at least about 60 wt %, as a further example at least about 70 wt %, or for example, at least about 75 wt % of oleic and/or linoleic acid or derivatives thereof based upon the total weight of the tall oil fatty acid. In some embodiments, the weight ratio of oleic acid and/or derivatives thereof to linoleic acid or derivatives thereof is from about 5:1 to about 1:5, for example, from about 4:1 to about 1:2, as a further example, from about 3.5:1 to about 1:1 based on the total weight of the oleic acid and/or derivative thereof and the linoleic acid or derivative thereof. One exemplary tall oil fatty acid may comprise a mixture of linoleic, oleic, and small amounts, e.g., less than about 5%, of other unsaturated and saturated fatty acids and is commercially available under the tradename Sylfat from Arizona Chemical Company. Additional exemplary tall oil fatty acids are disclosed in U.S. Patent Application Publication 2007/0049727 which is hereby incorporated by reference in its entirety.

In accordance with the presently disclosed methods, sulfur is removed from the tall oil fatty acid to a level of about 25 ppm or less. Sulfur may be removed from tall oil fatty acid using various techniques. In some embodiments, the sulfur may be removed by contacting the tall oil fatty acid with an adsorbent. The adsorbent may comprise any adsorbent having adsorbing capabilities, and exemplary adsorbents may include clay, acid-activated clay, silica, activated carbon, diatomaceous earth or combinations and/or mixtures thereof. A variety of adsorbents are well known and are commercially available. In many embodiments, the adsorbent may comprise acid-activated clay, for example, acid activated bentonite and/or montmorillonite, such as Tonsil Supreme 110 FF available from Sud-Chemie AG.

The adsorbent may have any particle size distribution that is capable of removing sulfur from the tall oil fatty acid. In some embodiments, the particle size may be such that less than 15%, for example, less than 12%, and as a further example, less than 10% of the particles have a size that is greater than 150 microns. In other embodiments, the particle size may be such that less than 25%, for example, less than 22%, and as a further example, less than 20% of the particles have a size that is greater than 100 microns. In still other embodiments, the particle size may be such that less than 35%, for example, less than 32%, and as a further example, less than 30% of the particles have a size that is greater than 63 microns. In further embodiments, the particle size may be such that less than 65%, for example, less than 62%, and as a further example, less than 60% of the particles have a size that is greater than 45 microns. In yet other embodiments, the particle size may be such that less than 35%, for example, less than 32%, and as a further example, less than 30% of the particles have a size that is greater than 25 microns. In one embodiment, the adsorbent may comprise a clay having a particle size distribution such that about 8% of the particles have a size that is greater than 150 microns, about 18% have a size that is greater than 100 microns, about 28% have a size that is greater than 63 microns, about 38% have a size that is greater than 45 microns, and about 58% have a size that is greater than 25 microns.

Contacting the tall oil fatty acid with an adsorbent may be performed by batch or continuous processing. For example, in some embodiments, contacting a tall oil fatty acid with an adsorbent may include stirring the fatty acid with an adsorbent, followed by any convenient separation process, e.g., filtration, centrifugation, and/or settling for removing the adsorbent and the sulfur adsorbed thereon. In many embodiments, this separation process may comprise filtration. Additionally or alternatively, the fatty acid may be contacted with the adsorbent in an adsorbent bed, e.g., a fixed or fluidized bed of adsorbent. The sulfur may be removed from a stream of tall oil fatty acid as the stream passes through the bed and the fatty acid contacts the adsorbent. In some embodiments, upon saturation of the adsorbent with sulfur from the tall oil fatty acid stream, the adsorbent may be subjected to a regeneration stage, to remove the adsorbed sulfur and allow the adsorbent bed to be reused.

Any amount of adsorbent may be used to adsorb sulfur from a tall oil fatty acid. However, in many embodiments, the amount of adsorbent may be from about 0.001% to about 50%, for example from about 0.01% to about 40%, as a further example, from about 0.1% to about 20%, or from about 1% to about 10% of adsorbent based upon the total weight of the tall oil fatty acid being treated.

In some embodiments the sulfur may be removed by distilling the tall oil fatty acid. Distillation may be performed using a short-path distillation column, a wiped film evaporator, a continuous column, a continuous fractionation column, or combinations thereof. An exemplary distillation technique may include continuously distilling the tall oil fatty acids at any temperature and pressure conventionally known in the art.

In some embodiments, the sulfur may be removed by a combination of contact with an adsorbent and distillation. While the sulfur is preferably removed in many embodiments by contact with an adsorbent alone, if contact with adsorbent and distillation are used in combination, in many embodiments, distillation is performed prior to contact with the adsorbent. For example, the tall oil fatty acid may be continuously distilled and any “cut” or portion of the distilled starting material and/or combination of cuts from the column may be removed and contacted with the adsorbent. Generally, there may be three portions to the distilling apparatus: a top cut, a bottom cut, and a middle cut. In an exemplified embodiment, a 75% middle cut may be removed from the distillation apparatus and subjected to adsorbing. While any % middle cut may be removed and subjected to adsorption, in many embodiments, at least a 40% middle cut, for example, from about 40% to about 95%, e.g., from about 50% to about 90%, may be removed and subjected to adsorbing. In other embodiments, the portion that is removed may be from about 0 to 50% of the bottom cut, or alternatively from about 0 to 50% of the top cut. In yet another embodiment, the middle cut that is subjected to adsorbing may comprise a combination of the top cut and the bottom cut. For example, a combination totaling about 40% or less of the top and bottom cuts may be removed and subjected to adsorption.

In many embodiments, sulfur may be removed from the tall oil fatty acid to a level of about 25 ppm or less. In some embodiments, the sulfur may be removed to a level of about 20 ppm or less, for example, about 15 ppm or less, or as a further example, to a level of about 10 ppm or less. The tall oil fatty acid, after having the sulfur removed, may contain about 25, 20, 15 or 10 ppm of sulfur, including any and all ranges and subranges therein.

Methods of producing lubricity additives according to the present disclosure further comprise fractionally crystallizing the tall oil fatty acid. Fractional crystallization may be used to separate different fatty acids or groups of fatty acids from one another based upon the differing rates at which they crystallize, e.g., precipitate, out of solution. For example, fractional crystallization may be used to separate saturated and unsaturated fatty acids from one another. In some applications, a fatty acid may be cooled to a temperature in which certain a certain fraction, e.g., a fraction comprising primarily saturated fatty acids crystallizes while another fraction, e.g., a fraction comprising primarily unsaturated fatty acids remains in solution. The crystallized fatty acid fraction may then be removed, for example by physical separation, such as filtration, leaving the remaining fatty acid fraction in solution.

In accordance with the present disclosure, the tall oil fatty acid may be fractionally crystallized to produce a lubricity additive comprising a fraction of tall oil fatty acids which additive does not form crystals at temperatures as low as about −20° F. A variety of fractional crystallization procedures may be used in accordance with the present disclosure. In one embodiment, a tall oil fatty acid may be cooled to a temperature of from about −24° C. to about −20° C. for a period of time ranging from about 0.5 hours to about 5 hours. The crystallized fatty acid fraction may then be removed, for example, using conventional filtration techniques, to isolate the fraction which did not form crystals.

Fractional crystallization may produce fractions of tall oil fatty acids having a variety of compositions. In many embodiments, fractional crystallization may produce a fatty acid fraction having a reduced concentration of saturated fatty acids, i.e., the fractionally crystallized fraction has a lower concentration of saturated fatty acids than the tall oil fatty acid prior to fractional crystallization. Although tall oil fatty acids may contain any amount of saturated fatty acids, in many embodiments, the tall oil fatty acid prior to fractional crystallization may contain about 5% or more of saturated fatty acids. In accordance with the present disclosure, fractional crystallization may produce a fatty acid fraction containing less than about 5% saturated fatty acids, for example about 4% or less saturated fatty acid, as a further example, about 3% or less saturated fatty acid, or even about 2% or less saturated fatty acid.

In some embodiments, the fractional crystallization is performed in the presence of a solvent. Solvents used in fractional crystallization may affect the rates at which different fractions crystallize and may facilitate filtration of the resulting fractions. Any of numerous solvents may be utilized, including for example, solvents that dissolve tall oil fatty acids at for example, room temperature, and produce crystals at some lower temperature. One exemplary solvent may include toluene. In many embodiments, the solvent may be removed, for example, by distillation after the crystallized fraction has been removed.

In some embodiments, the tall oil fatty acid which is fractionally crystallized may comprise a tall oil fatty acid from which sulfur has been removed, e.g., reduced to a level of about 25 ppm or less, as described above. In other embodiments, the tall oil fatty acid which is fractionally crystallized may have any sulfur level, wherein the resulting lubricity additive from this fraction, which does not form crystals at temperatures as low as about −20° F. may be treated, as described above, to reduce the sulfur level to about 25 ppm or less. Thus, in accordance with the presently disclosed methods, the sulfur removal and fractional crystallization may be used serially to produce the lubricity additives of the present disclosure and may be performed in any order.

In many embodiments, after the sulfur is removed and the fractional crystallization has been performed, the resulting lubricity additive may be combined with a solvent. Solvent may be added for a variety of reasons, including for example, to further dilute the sulfur content of the lubricity additive. The amount of solvent combined with the lubricity additive may vary widely. In some embodiments, the additive-solvent composition may comprise from about 50% to about 90% lubricity additive and from about 50% to about 10% solvent. In one exemplary embodiment, the additive-solvent composition may comprise about 60% lubricity additive and about 40% solvent.

Suitable solvents for this purpose are well known and commercially available. Some exemplary solvents may include hydrocarbons, such as aromatic hydrocarbons, non-aromatic cyclic hydrocarbons, branched hydrocarbons, and saturated hydrocarbons. More specifically, solvents may include xylene, heptane, and kerosene or those solvents commercially available under the tradenames SHELLSOL™ heptane and CYCLO SOL™ 100 Aromatic solvent (both available from Shell Chemical Company, Houston, Tex.), SOLVESSO™ 100 and 150 (available from ExxonMobil Chemical, Houston, Tex.), and CAROMAX™ products (available from Petrochem Carless, Surrey, UK). In many embodiments, the solvent comprises primarily xylene or isomers thereof, for example, as much as 100% xylene.

In some embodiments, the lubricity additives according to the present disclosure may be added to a fuel to improve the lubricity of the fuel and form a fuel composition. For example, in many embodiments the lubricity additive may be added to middle distillate fuels, such as diesel fuel, biodiesel fuel, aviation fuel, jet fuel, home heating oil, and bunker fuel. However, in other embodiments, the lubricity additive may be added to other fuels including, for example, gas oil, gasoline, and kerosene. The fuel may be a low sulfur fuel and/or an ultra low sulfur fuel. For example, the fuel may have a sulfur content of less than about 500 ppm, for example, less than about 350 ppm, as a further example, less than about 50 ppm, as a further example, less than about 25 ppm, as a further example, less than about 15 ppm or less than about 10 ppm. The fuel may also be sulfur free or essentially sulfur free containing no sulfur or only trace amounts of sulfur.

A fuel composition may include various amounts of lubricity additive and the amount may vary depending on the fuel and the composition of the lubricity additive. In an embodiment, from about 15 ppm to about 500 ppm, for example, from about 25 ppm to about 200 ppm of lubricity additive may be added to a fuel.

In some embodiments, the lubricity additives may be added or blended into or with a base fuel individually. In other embodiments, the lubricity additives may be used as components in forming preformed additive combinations and/or sub-combinations. Additive packages which may include any of a variety of additives, are typically specifically tailored to the intended end use and/or function of the fuel. Additive packages may include, but are not limited to, solvents, biocides, detergents, corrosive inhibitors, cetane improvers, dyes, and antistatic compounds.

The example that follows is intended to further illustrate, and not limit, embodiments in accordance with the invention. All percentages, ratios, parts, and amounts used and described herein are by weight unless indicated otherwise.

### EXAMPLE

This Example illustrates a method of fractionally crystallizing a tall oil fatty acid according to an embodiment of the present disclosure.

A first solution comprising 70 wt % tall oil fatty acid comprising approximately 66% linoleic acid, approximately 28% oleic acid, approximately 2% saturated fatty acids and approximately 2% other fatty acids and having a sulfur level of 25 ppm or less (available as Sylfat LS20T from Arizona Chemical Company, having a sulfur content of 18 ppm and a cloud point of −8° C.) and 30% toluene was subjected to the following fractional crystallization procedure: the solution was cooled to −22° C.±2° C. for 18 hours and the resulting mixture was filtered at −22° C. through Whatman #1 filter paper to remove the crystallized fraction. Toluene was removed from the filtrate by distillation with flowing nitrogen. The fatty acid distillate was blended with the solvents identified in the Table in the amounts indicated and was cooled to −20° F. (−28.9° C.). The fatty acid after this fractional crystallization had a sulfur content of 18 ppm and a cloud point of −21° C. The compositions were observed after 5 hours for the appearance of crystals. A comparison solution, comprising 70 wt % of the same tall oil fatty acid described above and 30% toluene was not subjected to the fractional crystallization procedure, but was simply combined with the identified solvents in the identified amounts and observed after 5 hours at −20° F. for the appearance of crystals. The results for both compositions are reported below.

TABLE

| | | AROMATIC | 2- | |
|---|---|---|---|---|
| | SYLFAT | 100 SOLVENT | ETHYLHEXANOL | |
| TEST | LS20LT (wt %) | (wt %) | (wt %) | APPEARANCE |
| 1 | 60 | 40 | — | Clear solution w/ |
| | | | | few crystals |
| 2 | 60 | 35 | 5 | Clear solution; no |
| | | | | crystals |
| 3 | 60 | 30 | 10 | Clear solution; no |
| | | | | crystals |
| Comparison | 60 | 40 | — | Opaque w/ crystals |
| Comparison | 60 | 35 | 5 | Opaque w/ crystals |
| Comparison | 60 | 30 | 10 | Opaque w/ crystals |

The above results clearly demonstrate that low sulfur tall oil fatty acids which have been subjected to fractional crystallization form clear solutions with no crystals or only relatively few crystals at temperatures as low as −20° F., while conventional tall oil fatty acids, which have not been subjected to fractional crystallization, do not remain free of crystals at such low temperatures. Accordingly, the presently disclosed methods and additives provide numerous advantages over conventional tall oil fatty acid additives in the art. One significant advantage is that the additive remains free of crystals at such low temperatures and thus provides an additive having improved low temperature stability.

It is to be understood that the reactants and components referred to by chemical name anywhere in the specification or claims hereof, whether referred to in the singular or plural, are identified as they exist prior to coming into contact with another substance referred to by chemical name or chemical type (e.g., base fuel, solvent, etc.). It matters not what chemical changes transformations, and/or reactions, if any, take place in the resulting mixture or solution or reaction medium as such changes, transformations and/or reactions are the natural result of bringing the specified reactants and/or components together under the conditions called for pursuant to this disclosure. Thus, the reactants and components are identified as ingredients to be brought together either in performing a desired chemical reaction or in forming a desired composition. Accordingly, even though the claims hereinafter may refer to substances, components, and/or ingredients in the present tense (“comprises”, “is”, etc.), the reference is to the substance, component or ingredient as it existed at the time just before it was first blended or mixed with one or more other substances, components, and/or ingredients in accordance with the present disclosure. The fact that the substance, component, or ingredient may have lost its original identity through a chemical reaction or transformation during the course of such blending or mixing operations is thus wholly immaterial for an accurate understanding and appreciation of this disclosure and the claims thereof.

All of the references cited herein, including publications, patents, and patent applications, are hereby incorporated in their entireties by reference.

While this invention has been described with an emphasis upon certain embodiments, it will be obvious to those of ordinary skill in the art that variations of the embodiments may be used and that it is intended that the invention may be practiced otherwise than as specifically described herein. Accordingly, this invention includes all modifications encompassed within the scope of the invention as defined by the following claims.

What is claimed is:

1. A method of producing a lubricity additive comprising:
removing sulfur from a tall oil fatty acid to a level of about 25 ppm or less, and fractionally crystallizing the tall oil fatty acid to produce a lubricity additive in which crystals do not form at temperatures as low as about −20° F.

2. The method of producing a lubricity additive according to claim 1 wherein the sulfur is removed prior to fractionally crystallizing the tall oil fatty acid.

3. The method of producing a lubricity additive according to claim 1 wherein the sulfur is removed after fractionally crystallizing the tall oil fatty acid.

4. The method of producing a lubricity additive according to claim 1 wherein removing the sulfur comprises contacting the tall oil fatty acid with an adsorbent.

5. The method of producing a lubricity additive according to claim 4 wherein the adsorbent is selected from one of clay, acid-activated clay, silica, activated carbon, diatomaceous earth and combinations and/or mixtures thereof.

6. The method of producing a lubricity additive according to claim 4 wherein removing the sulfur further comprises distilling the tall oil fatty acid.

7. The method of producing a lubricity additive according to claim 1 wherein fractionally crystallizing the tall oil fatty acid comprises reducing the level of saturated fatty acids in the tall oil fatty acid to a level of less than about 5%.

8. The method of producing a lubricity additive according to claim 7 wherein fractionally crystallizing the tall oil fatty acid comprises reducing the level of saturated fatty acids in the tall oil fatty acid to a level of less than about 2%.

9. A lubricity additive comprising a fraction of tall oil fatty acids having a sulfur content of less than about 25 ppm, wherein the additive does not form crystals at temperatures as low as about −20° F.

10. The lubricity additive according to claim 9 further comprising a solvent.

11. The lubricity additive according to claim 10 comprising from about 50% to about 90% tall oil fatty acid and from about 50% to about 10% solvent.

12. The lubricity additive according to claim 11 wherein the sulfur content is not more than about 15 ppm.

13. The lubricity additive according to claim 9 wherein the tall oil fatty acid has a weight ratio of oleic acid and/or derivatives thereof to linoleic acid or derivatives thereof of from about 5:1 to about 1:5.

14. A method of improving the lubricity of a fuel comprising:
removing sulfur from a tall oil fatty acid to a level of about 25 ppm or less;
fractionally crystallizing the tall oil fatty acid;
diluting the fractionally crystallized fatty acid with a solvent to form a lubricity additive which does not form crystals at temperatures as low as about −20° F.; and
adding the lubricity additive to a fuel.

15. The method of improving the lubricity of a fuel according to claim 14 wherein diluting the fractionally crystallized fatty acid comprises adding solvent until the diluted fatty acid has a sulfur level of about 15 ppm or less.

16. The method of improving the lubricity of a fuel according to claim 14 wherein from about 25 ppm to about 200 ppm of diluted fatty acid are added to the fuel.

17. The method of improving the lubricity of a fuel according to claim 14 wherein the fuel comprises a middle distillate fuel.

18. A fuel formed by the method of claim 14.

19. The fuel of claim 18, wherein the fuel is a middle distillate fuel selected from the group consisting of diesel fuel, biodiesel fuel, aviation fuel, jet fuel, home heating fuel, and bunker fuel.
